(19) United States
(12) Patent Application Publication
(10) Pub. No.: US 2016/0037200 A1
(43) Pub. Date: Feb. 4, 2016

(54) System and Method for Aggregated Multimedia Content Streaming

(71) Applicant: Leroy Gordon, Brooklyn, NY (US)

(72) Inventor: Leroy Gordon, Brooklyn, NY (US)

(73) Assignee: OPENVISION NETWORKS, INC., Riverdale, NY (US)

(21) Appl. No.: 14/810,941

(22) Filed: Jul. 28, 2015

Related U.S. Application Data
(63) Continuation of application No. 61/999,525, filed on Jul. 30, 2014.

(51) Int. Cl. H04N 21/2665; H04L 12/18; H04N 21/2343; H04N 21/462; H04N 21/61; H04N 21/482; H04N 21/485; H04L 29/06; H04N 21/262

(52) U.S. Cl. CPC H04N 21/2665; H04L 65/608; H04L 65/4076; H04L 12/1881; H04N 21/234309; H04N 21/26283; H04N 21/6125; H04N 21/482; H04N 21/4852; H04N 21/4622

(57) ABSTRACT

The present invention provides a system and method which aggregates disparate multimedia sources into a plurality of utility services or channels, which are accessible to a plurality of networked computing devices without the utilization of a web browser or a set-top box. Such system of distribution would enable a seamless experience to view multimedia broadcasts by navigating through channels displaying media content in full screen, including high definition video and high fidelity audio, thereby emulating the experience provided by traditional broadcast television, cable or satellite. The user is not required to download or install a browser or any proprietary plug-in or to have any physical set-top box in order to use the present invention. Channel navigation can be done on an interactive touch screen devices, wherein channels and volume can be changed.

### CROSS-REFERENCE TO RELATED APPLICATION

This application claims priority of U.S. Provisional Patent Application Ser. No. 61/999,525 filed on Jul. 30, 2014, which is incorporated herein by reference in its entirety.

### FIELD OF THE INVENTION

The present invention relates to a method and system, implemented using a client software application program for aggregating disparate media sources which emulates the functions of a cable or satellite TV service, into a plurality of designated utility services or channels wherein said channels are accessible to a plurality of computers having internet connection without utilizing a web browser or set-top box.

### BACKGROUND OF THE INVENTION

The birth of internet made various ways of communicating possible. The internet was originally intended mainly for transmission and exchange of information such as files and electronic mails. However, as the potential of the internet rise, other types of communications were enabled. Examples are the video and audio transmissions, which are considered important as those file transfers which the internet made possible. Many technologies support the transmission of digital multimedia signals over a global network transmission such as the internet. These technologies includes Quicktime™ wherein movie files can be transmitted across the globe via the Internet. Quicktime™ supports both video and audio formats. Many other file formats allow video and audio to be displayed on various users' networked computing devices.

In order to have access to such technology, a user needs to have a web browser installed on a computer. The computer, acting as a client, using the web browser is capable of communicating with various web servers wherein each web server will typically produces hypertext markup language (HTML) files to the clients. The files may include texts, graphics references, interactive multimedia contents and references to specialized files. Some of these specialized files may include multimedia data contents such as video and audio information in proprietary formats which the client can view once they are downloaded using a proprietary plug-in. However, the use of a web server, including a plug-in, has gained significant drawbacks. A user must download proprietary software and/or plug-ins before they can view the multimedia broadcasts. The user is also forced to download a new player or application every time the system is updated in order to receive the latest features. This creates a tedious experience for the user, an often frustrating experience for a user who is not well-versed in utilizing networked computing devices such as computers and smart phones. Such frequent download of new proprietary software further leaves the user's computer susceptible to virus or spyware attack that may affect the computers' performance.

Multimedia streaming can be transmitted over the internet allowing content providers to broadcast long and/or live video and audio transmissions across the global network on a continuous basis. A user, thru a client, can access the data stream and regenerate the multimedia data signal while being transmitted. Streaming technology is particularly useful where the events are live, or where the files would be so large as to be a burden on the end users. Multimedia streaming is of great help in events such as display of conferences, sports event coverage, radio broadcasts, television broadcasts and the like.

Recent advances in technology made it possible for viewers to watch entertaining video clips, television shows and other video broadcasts over a plurality of networked computing devices. A number of systems have been created and developed which allows users to receive the stream of such multimedia content through internet websites. Examples of such system are Netflix®, Slingbox®, YouTube®, Hulu® and Joost®. These systems typically allow a user to search for specific multimedia content and view said content over a broadband internet connection using a browser and/or set top box from cable service providers.

However, the above mentioned systems do not provide a user with a seamless viewing experience. The use of a browser or set-top box is required in order to view the multimedia contents being broadcasted. It also requires users to search for specific content when viewing various programs, for example, by entering specific keywords or by scrolling through available media content.

Furthermore, said systems do not provide the user with the ability to simply change channels in order to view additional media content without leaving the current full screen view, as if the user is viewing the programs on an actual television. Said drawbacks impair the systems' ability to provide worthwhile experience to the users or subscribers.

For instance, the video streaming offered by Slingbox® requires a user to utilize a set top box in order to receive a video stream, since it cannot broadcast multimedia contents to anyone who is not within the cable's geographically limited subscriber's database. Although Slingbox® application gives the user the capacity to change and shift channels using gestures, said application still needs to be connected to a dedicated modem module linked via infrared emitters to a cable service provider's set top box.

Despite the rapid growth of flexibility using networked computing devices to transmit, receive and playback multimedia content over the internet, a vast majority of individuals especially the elderly would still prefer television as a primary source of receiving video and audio transmission. Specifically, over-the-air satellite and cable broadcast systems transmitting multimedia contents in television still represent the dominant means by which multimedia is communicated to, and viewed by individuals. Those broadcast transmissions however are restricted to cost, range of content, access time and geographical locations where reception signal is intermittent.

A system and method of providing streaming audio and video data to multiple users is disclosed in U.S. Pat. No. 6,711,622 B1, wherein its server concurrently provides streaming audio and video data to the clients using browsers. Said browsers do not require the use of a plug-in or helper application to receive and utilize the streaming audio and video.

Said system which provides audio and video data to a plurality of browser clients comprises a real-time video and audio server computer, operative as a client computer as it receives and processes streaming video or audio data from at least one remote server; and a web server computer in communication with said real-time video and audio server computer for receiving processed streaming video or audio data from said real time video and audio server computer and to transmit said processed streaming video or audio data, without a plug-in or a helper application, to said plurality of browser clients. Said web server continually transmit said processed streaming video or audio data to individual browser clients of said plurality of browser clients until the individual browser clients instruct said web server to stop. The system utilizes a browser so that it can allow a client to make a request to a web server where the result of the request is processed thereof. It is a part of a stand-alone application or a set of programs which are integrated into the operating system of the client. Said plug-in is an external software programs that extend the capabilities of the browser in a specific way such as to play audio samples or view video movies from within the browser. The said helper application is an external software program wherein the browser redirects some types of file to the helper applications to allow clients to process many different types of files on the internet. Whenever the browser encounters a sound, image or video file, the browser hands-off the data to the helper application to run or display the file.

Although said system does not require the use of any plug-in or application helper when obtaining the streaming in a browser, a significant drawback has been observed in the use of such browser in that the user needs to type the website wherein the streaming would be viewed every time the service is used. Some networked devices do not or have limited support in the use of a browser. Thus, it makes it impossible for the said devices to receive audio and video streams online, especially when viewing live streaming feeds in high definition video and high fidelity audio formats. Also, the manual changing of channel when using a browser limits the optimal user experience since the user is forced to search or scroll through the listings of available multimedia content each time the user wishes to stream and view various multimedia contents which are being broadcasted. Hence, the user cannot continue viewing the streaming content an the current channel in full screen while selecting the next channel to be viewed.

Furthermore, conventional user interface includes multiple key sequences using push buttons and complex menu hierarchies in changing channels and/or volume.

### SUMMARY OF THE INVENTION

The present invention as herein disclosed tends to solve the aforementioned drawbacks by providing a system which aggregates disparate multimedia sources into a plurality of utility services or channels, which are accessible to a plurality of networked computing devices without the utilization of a web browser or a set-top box. Such system of distribution would enable a seamless experience to view multimedia broadcasts by navigating through channels displaying media content in full screen, thereby emulating the experience provided fey traditional broadcast television, cable or satellite. The user is not required to download or install a browser or any proprietary plug-in or to have any physical set-top box in order to use the present invention. Channel navigation can be done on an interactive touch screen devices, wherein channels and volume can be changed thereof through adaptive gesture recognition such as finger swiping or other bodily gestures.

The present invention further addresses the shortcomings associated with the available systems and methods of multimedia transmissions, if provides a method which aggregates disparate media sources or content providers into a plurality of designated utility services/channels accessible to a plurality of networked computing devices without utilizing a web browser or set-top box. Embodiments of the present invention allows the distribution of video contents, in high definition format, combined with audio signals, in high fidelity format, from the content providers via the internet or other wireless distribution system. A client software application is installed on various clients such as smart TV's, smart phones, tablets, personal computers, laptops and the like such that a user would be able to receive and interact with multimedia content. To be able to start receiving and interacting with said content, a user opens the client software application (App) and a private TV channel appears wherein any other channels can also be selected. Different types of multimedia contents are being organized in a channel line-up configuration without utilizing a web browser interface to view such contents or the use of a set-top box to connect to the App. The channel line-up is presented to be interactive in format, wherein a user can change the channels by using simple body gestures and movements such as finger swiping in interactive touch screen enabled devices. Meanwhile, a keyboard, mouse, remote control or sensors can be used in all other devices to change the channel and volume.

Furthermore, to avoid the complex menu system when shifting between channels, simple gestures such finger swiping on interactive touch screen computing devices are utilized; and hand and/or body movements on sensor activated computing devices thereby translating detected precise user gestures into precise, intended commands to be performed.

Other objects and advantages of the present invention will be realized upon reading the following description taken in conjunction with the accompanying drawings.

### BRIEF DESCRIPTION OF THE SEVERAL VIEWS OF THE DRAWINGS

FIG. 1 is a diagram showing the system for aggregating, processing and distributing multimedia contents streaming of the present invention.

FIG. 2 is a diagram of the multimedia aggregating means of the present invention.

FIG. 3 is a flow chart of the method for aggregating multimedia contents.

FIG. 4 is a flow chart for obtaining access to multimedia streaming service.

### DETAILED DESCRIPTION OF THE INVENTION

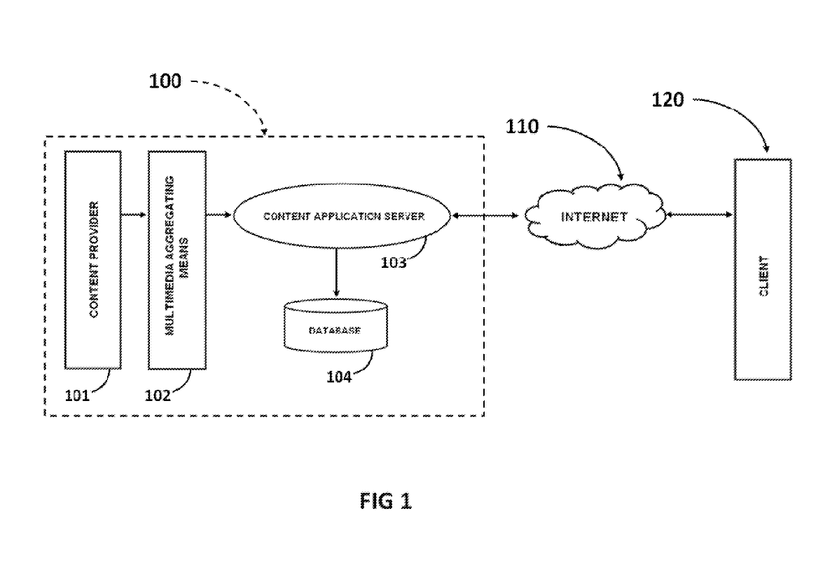

There is shown in FIG. 1 a system for aggregated multi-media streaming being made such that it is capable of aggregating, processing and distributing multimedia contents, including video and audio in high definition and fidelity formats from disparate media sources or content providers. Said system comprising a server 100, a communication interface 110 in communication with said server 100 and client 120 in communication with said communication interface 110. Said server 100 includes a content provider 101 in communication with a multimedia aggregating means 102, and a content application server 103 communicating with said multimedia aggregating means 102. Said content provider 101 may be a satellite link station, broadcast tower station or internet streaming sources. Said content provider 101 being capable of transmitting various multimedia contents, such as video and audio formats, from several disparate means, such as satellite link stations, TV and radio broadcast towers and HTTP streaming from other media sources such as video cameras, smart phones, computers and other computing devices capable of accessing the internet over a broadband connection using a communication unit such as a modem, a TI line, a satellite connection and the like.

Transmission of multimedia streams from a plurality of content providers can be in the format of either MPEG2-Transport Stream (MPEG2-TS) or MPEG-4 Advanced Video Coding (MP4 H.264). MPEG2-TS is a standard transmission format and storage of audio, [symbol] systems such as Digital Video Broadcasting (DVB), Advanced Television Committee Standards (ATSC standards) and Internet Protocol Television (IPTV). H.264 is another video coding format for recording, compression and distribution of video content. It is mostly used by streaming internet sources such as Vimeo™, YouTube™ and other HDTV broadcasts over terrestrial (ATSC Standards, ISDB-T, DVB-T or DVB-T2), cable (DVB-C) and satellite (DVB-S and DVB-S2).

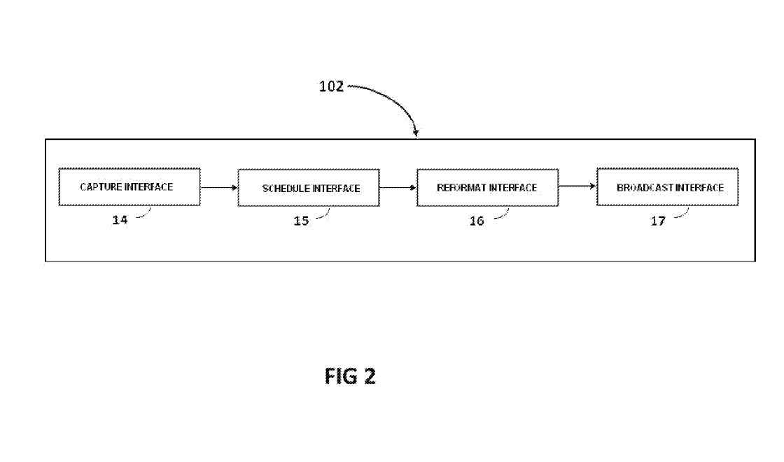

The multimedia contents are transmitted by the content provider to the multimedia aggregating means 102 through wireless connection such as radio frequencies, internet, satellite or other broadcasting means. Said multimedia aggregating means 102 being capable of operating on a Linux® multi-core CPU. FIG. 2 shows a detailed diagram of the multimedia aggregating means 102, wherein disparate multimedia contents are being scheduled and reformatted on a distribution channel and being received on plenary devices, each with authoritative access and control of available distribution channels. Said multimedia aggregating means 102 includes inter-communicating interfaces such as capture interface 14, schedule interface 15, reformat interface 16 and broadcast interface 17. Capture interface 14 being capable of receiving and collating the transmitted multimedia data contents or signals from the content provider 101. Said capture interface further facilitates authentication of the content provider and broadcast identification of the multimedia data signals. In case of authentication failure, entry of multimedia data contents will be denied and error message will be sent back to the content provider informing about the authentication failure. In case there is authentication, the collated multimedia data contents or signals are then transmitted to the schedule interface 15. Said schedule interface 15 being configured such that it is capable of organizing and allocating the authenticated multimedia data contents to corresponding channel/s including designating the time slots on which it can be broadcasted. The organized and allocated multimedia data contents are then transmitted to the reformat interface 16. Said reformat interface 16 being capable of transcoding said multimedia contents such that the format is compatible to a possible client 120. After reformatting, the multimedia data contents is sent to the broadcast interface 17, which is capable of transmitting the reformatted multimedia data contents to the content application server 103. The content application server 103 is being configured such that it is capable of receiving the processed multimedia data contents from the multimedia aggregating means 102. The processed multimedia data contents are then allowed to stream thereof until a browser-less client 120 requests for access to the stream via the internet.

The provision of a multimedia aggregating means allows the system to access a multimedia data contents without utilizing a browser or any set-top box. Said multimedia aggregating means allows client 120 the ease of accessing multimedia content streaming in high resolution video and high fidelity audio.

The client 120 is embodied by any networked computing device including but not limited to smart TVs, smart watches, PCs/laptops (MacOS™, Windows®, Linux®), smart phones, tablet computers and smart homes/smart appliances, wherein the user interacts with the device by receiving the multimedia content being distributed on the channel that the device is currently accessing and being able to tune-in to another channel in-place, by executing defined bodily movements and gestures with or without the aid of a controlling device.

Certain parameters are set such that the bodily movements and gestures would closely match an actual movements indicated by user inputs. Said movements and gestures may include gliding of one or two fingers into a touch sensitive screen of a computer wherein a single press on the screen shows the current channel being viewed. If the fingers' glide is directed to the left side, the current stream is shifted to a lower channel number while if the fingers' glide is directed to the right side, the current stream is shifted to a higher channel number. Once the finger/s are lifted is/are lifted from the screen, the shifting of channels fake effect. Volume is controlled by gliding the finger up or down. If glide is directed upwards, the volume is increased; otherwise, if the glide is directed downwards, the volume is decreased.

The client receives the multimedia streaming data in the format of MP4 H.264 over Real Time Messaging Protocol (RTMP), HTTP Live Streaming (HLS) or HTTP. RTMP is a TCP-based protocol which maintains persistent connections and allows low-latency communication. To deliver streams smoothly and transmit as much information as possible, it splits streams into fragments and their size is negotiated dynamically between the client and server while sometimes it is kept unchanged: the default fragment sizes are 64-bytes for audio data, and 128-bytes for video data and most other data types. Fragments from different streams may then be interleaved, and multiplexed over a single connection. With longer data chunks the protocol thus carries only a one-byte header per fragment, so incurring very little overhead. HLS works by breaking the overall stream into a sequence of small HTTP-based file downloads each download loading one short chunk of an overall potentially unbounded transport stream. As the stream is played, the client may select from a number of different alternate streams containing the same material encoded at a variety of data rates, allowing the streaming session to adapt to the available data rate.

The user connects to the content application server 103 by logging-in to the client software application installed in the client. Once connected, the user, thru clients, 120 makes requests for multimedia contents from the content application server 103, said server responds to the request and provides access to multimedia contents over the internet. A database 104 is used by the content application server 103 to store user information, such as account information or usage habits relating to subscribers.

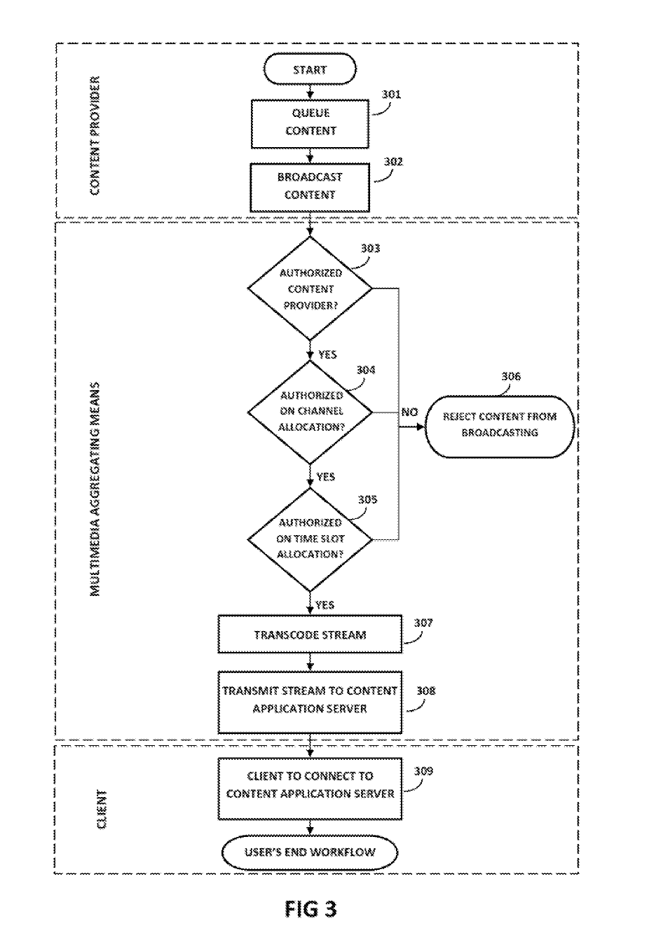

FIG. 3 shows a flow chart of the process on how multimedia contents are being broadcasted from content providers to the clients. The content providers queue multimedia contents 301 to be broadcasted 302 to a multimedia aggregating means. The multimedia contents which had bean transmitted by the content providers are being received in a multimedia aggregating means. Several authorization checks are than done inside the multimedia aggregating means to authenticate if the content providers are authorized to broadcast such contents. The content providers are checked if they are authorized to broadcast 303, if not, the transmitted contents are rejected 306. Once the content providers are authorized to broadcast contents, the multimedia aggregating means checks if the broadcasted contents have authorization on channel allocation 304, if not, the transmitted contents are rejected 306. Once channel allocation is authorized, the multimedia aggregating means checks if broadcast contents have authorization on a time slot allocation 305, if not, the transmitted contents are rejected 306.

Once the multimedia contents which have been transmitted by the content providers have been fully authenticated, said contents are then transcoded 307 in a format compatible for streaming in a user's client. Said multimedia streams are then transmitted to the content application server 308 so that when the user requests for a streaming content, they would be readily available. The user, thru a client, must connect to the content application server 309 using an App in order to gain access to multimedia streaming service.

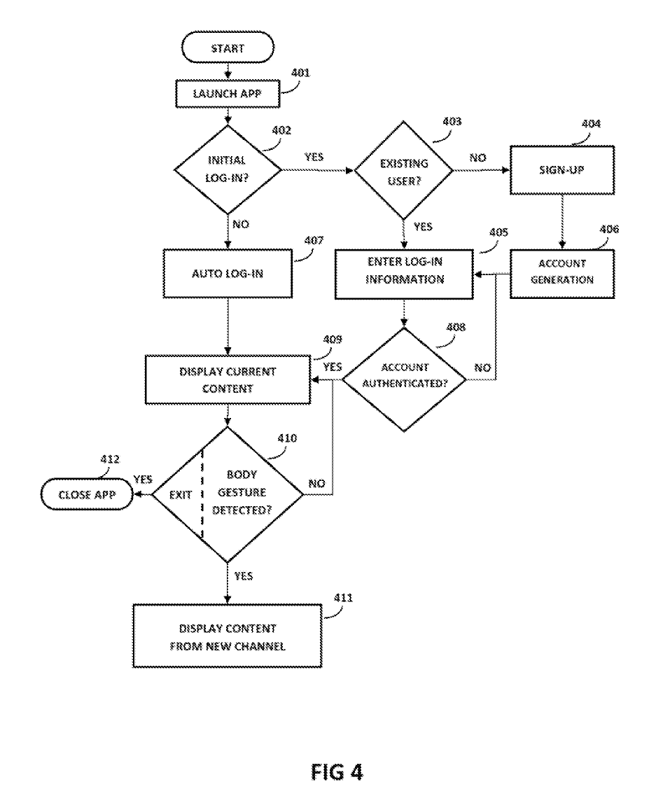

FIG. 4 shows a flow chart of the process in obtaining access to multimedia streaming service. A user must have a networked computer to be able to use the streaming service. A user downloads and installs a streaming application (App) for the first time. Said App is then run by the user on a preferred client.

The user launches the App 401 using a computer connected to the internet For users using a new client, an initial log-in 402 is required. A log-in screen is then introduced requiring the user to enter log-in information such as a user name or email address and a password. If the user has an existing account 403, the log-in information 405 required must be entered to be authenticated 408 and allowed to gain access to streaming and display multimedia contents 409. if the user does not have an existing account, the user is required to sign-up 404 and to create a new account. Once the user creates a new account, said user enters the required log-in information 405 such as a valid email address, password and personal information such as complete name, date of birth, address, etc. Upon entering said information, the streaming application then automatically generates an account 406 and logs-in to the application to get access to multimedia streaming. Automatic log-in (Auto Log-in) 407 is available for users accessing the App for a subsequent time using the same computer. Once the user has logged-in, an encrypted key is sent by the server to be used on subsequent launches of the application to authenticate the user without having to constantly logging-in every time the service is being used.

Once the user is already streaming using the App, said user may opt to switch between channels by using body gestures 410 such as swiping the screen display of an interactive touch enabled client. Once the App defects the gesture, it will automatically switch and change the current channel and display another multimedia content 411 from new channel. Said user may also opt to exit the service at any particular time.

The App is configured to log-in and authenticate existing users; and create an account for new users. It is configured to track users' viewing activity based on the channels being viewed at a particular time. It is configured to provide targeted advertising strategies and promotional advertisements to advertisers. It is also configured to deliver genre driven content to the users including but not limited to live event streaming, pay-per-view streaming, scheduled streaming, on-demand streaming, and interactive streaming.

[symbol]

1. A system for aggregated multimedia content streaming comprising:
a server which includes a content provider, a multimedia aggregating means in communication with said content provider and a content application server communicating with said multimedia aggregating means, a client in communication with said server through a communication interface and a client, software application being capable of streaming multimedia contents utilizing said client, characterized in that said multimedia aggregating means includes a plurality of interconnected interfaces being arranged such that it is capable of receiving, processing and transmitting multimedia contents from said content provider to said client, said multimedia aggregating means consisting of a capture interface being configured in a manner wherein it is capable of receiving, collating, authenticating multimedia contents and provides broadcast identification on the multimedia contents received from the content provider, a schedule interface being configured such that it is capable of organizing the authenticated multimedia contents such that it is provided with corresponding channel and designated time slots on which it can be broadcasted, a reformat interface being capable of transcoding said multimedia contents into a format compatible to said client, and a broadcast interface being configured such that it is capable of transmitting the transcoded multimedia contents to the content application server.

2. A system for aggregated multimedia content streaming according to claim 1, wherein said content provider belongs to the group which includes satellite link station, tv and radio broadcast tower station, internet streaming source, video camera, smart phone and other computing devices capable of accessing communication interface.

3. A system for aggregated multimedia content streaming according to claim 1, wherein said client belongs to the group which includes smart tv, personal computer, laptop, tablet computer, smart phone, smart watch and smart home system/appliances capable of accessing communication interface.

4. A system for aggregated multimedia content streaming according to claims 1 to 3, wherein said communication interface is the internet.

5. A system for aggregated multimedia content streaming according to claim 1, wherein said transcoded multimedia contents is in the format of MP4 H.264 over Real Time Messaging Protocol (RTMP) or HTTP Live Streaming (HLS).

6. A system for aggregated multimedia content streaming according to claim 1, wherein said client software application is configured such that it is capable of navigating channels and change volume by detecting bodily movements or gestures.

7. A system for aggregated multimedia content streaming according to claim 7 wherein said gesture includes finger/s swiping either from left to right or vice versa to navigate channels and finger swiping either from up to down or vice versa to change the volume.

8. A method for aggregated multimedia content streaming, comprising the steps of:
processing multimedia contents from a content provider, allowing said processed multimedia contents to stream until there is a browser-less client request utilizing a client software application for access to the stream, transmitting the requested stream to said client for viewing said stream, characterized in that said processing multimedia contents includes:
a) collating and authenticating said multimedia contents,
b) providing broadcast identification to said multimedia contents,
c) organizing the authenticated multimedia contents,
d) providing the organized multimedia contents with corresponding channel and designated time slot,
e) transcoding the organized multimedia contents into a format compatible to said client,
f) allowing the transcoded multimedia contents to be streamed through communication interface.

9. A method for aggregated multimedia content steaming according to claim 8, wherein said content provider belongs to the group which includes satellite link station, tv and radio broadcast tower station, internet streaming source, video camera, smart phone and other computing devices capable of accessing communication interface.

10. A method for aggregated multimedia content streaming according to claim 8, wherein said client belongs to the group which includes smart tv, personal computer, laptop, tablet computer, smart phone, smart watch and smart home system/appliances capable of accessing communication interface.

11. A method for aggregated multimedia content streaming according to claims 9 to 10, wherein said communication interface is the internet.

12. A method for aggregated multimedia content streaming according to claim 8, wherein said transcoded multimedia contents is in the format of MP4 H.264 over Real Time Messaging Protocol (RTMP) or HTTP Live Streaming (HLS).

13. A method for aggregated multimedia content steaming according to claim 8, wherein said client software application is configured such that it is capable of navigating channels and change volume by detecting bodily movements or gestures.

14. A method for aggregated multimedia content streaming according to claim 13 wherein said gesture includes finger/s swiping either from left to right or vice versa to navigate channels and finger swiping either from up to down or vice versa to change the volume.
